(19) United States
(12) Patent Application Publication
(10) Pub. No.: US 2025/0270401 A1
(43) Pub. Date: Aug. 28, 2025

(54) ELASTOMER MATRIX COMPRISING A THERMOPLASTIC ELASTOMER

(71) Applicant: COMPAGNIE GENERALE DES ETABLISSEMENTS MICHELIN, Clermont-Ferrand (FR)

(72) Inventors: CHARLOTTE DIRE, Clermont-Ferrand (FR); KARIMA HABHAB, Clermont-Ferrand (FR); MATHILDE TOUSTOU, Clermont-Ferrand (FR); JEAN COUE, Clermont-Ferrand (FR)

(21) Appl. No.: 18/858,018

(22) PCT Filed: Apr. 11, 2023
(86) PCT No.: PCT/EP2023/059437

§ 371 Date: Oct. 18, 2024

(30) Foreign Application Priority Data
Apr. 21, 2022 (FR) FR2203718

(51) Int. Cl. C08L 53/02; B60C 1/00

(52) U.S. Cl. CPC C08L 53/02; B60C 1/00; C08L 2205/025; C08L 2205/03

(57) ABSTRACT

An elastomer matrix comprises: a triblock thermoplastic elastomer having a central diene elastomer block and two terminal thermoplastic blocks comprising a-methylstyrene units bonded to the diene elastomer block; from 2% to 20% by weight of a diblock thermoplastic elastomer having a diene elastomer block and a thermoplastic block comprising α-methylstyrene units; and more than 10% by weight of a thermoplastic polymer comprising α-methylstyrene units. The content of thermoplastic blocks is at least 10% by weight, with respect to the total weight of the triblock and diblock thermoplastic elastomers, the content of thermoplastic chains comprising a-methylstyrene units is at most 55% by weight, with respect to the total weight of the elastomer matrix, and the thermoplastic chains comprising α-methylstyrene units are constituted of the chains of the thermoplastic polymer comprising α-methylstyrene units and of the thermoplastic blocks of the triblock and diblock thermoplastic elastomers.

### TECHNICAL FIELD OF THE INVENTION

The present invention relates to an elastomer matrix comprising a triblock thermoplastic elastomer having a diene elastomeric block and two thermoplastic blocks comprising a- methylstyrene units.

### PRIOR ART

In the field of tyres for motor vehicles, the Applicant Company has in the past developed rubber compositions comprising a thermoplastic elastomer. These tyres exhibit a very good compromise in terms of grip and rolling resistance performance qualities.

Thermoplastic elastomers (TPE) are elastomers which are of great interest in many fields because of their combined properties related, on the one hand, to the elastomer block and, on the other hand, to the rigid thermoplastic block. Moreover, the association of the rigid thermoplastic blocks with one another gives the material the behaviour of a crosslinked elastomer. This is because the rigid nodules, formed by the zones of associations of thermoplastic blocks with one another, play the role of crosslinking node. The material is thus rigid and does not flow. On the other hand, when the temperature is raised above the glass transition temperature or the melting point of the rigid blocks, the polymer will be able to flow, making possible the shaping of the material. The latter regains its rigidity when the temperature returns to the level of the operating temperature, which is lower than the Tg of the thermoplastic blocks. This distinguishing feature of TPEs implies very wide application potential.

These thermoplastic elastomers include copolymers having poly(α-methylstyrene) blocks which have the advantage of exhibiting high thermal strength since the rigid blocks are poly(α-methylstyrene) blocks exhibiting a high Tg of approximately 150-170° C. These thermoplastic elastomers are widely described in the state of the art, in the academic literature or also in the patent documentation. Among these thermoplastic elastomers, some are described as having thermoplastic blocks which are copolymers of α-methylstyrene and of another monomer, such as styrene, as in WO 2007112232A2, for example. Other documents describe TPEs, the thermoplastic blocks of which consist exclusively of units resulting from α-methylstyrene, such as, for example, FR 2 243 214.

Polymer compositions based on copolymers having poly(α-methylstyrene) blocks targeted at achieving various objectives have also been described. Thus, EP 1 498 455 A1 describes a polymer composition comprising a block thermoplastic elastomer, one block of which is mainly composed of α-methylstyrene and one block of which is composed of a conjugated diene, and also an acrylic resin and a plasticizer. For its part, EP 2 955 203 A1 describes a polymer composition comprising a block thermoplastic elastomer, one block of which is mainly composed of α-methylstyrene and one block of which is composed of a conjugated diene, and also another thermoplastic elastomer associated with a polypropylene and a polyethylene. Also, WO 2020136194 describes a polymer composition comprising a block thermoplastic elastomer, one block of which is mainly composed of α-methylstyrene and one block of which is composed of a conjugated diene, and also a plasticizer chosen from oligobutadienes.

In this prior art, great emphasis is placed on the physical properties of the polymer compositions, in particular the mechanical properties, such as the scratch resistance, the abrasion resistance, the flexibility, the rigidity and the mechanical strength. Furthermore, EP 1 498 455 A1, section [0053], EP 2 955 203 A1, section and FR 2 243 214, page 3, line 17, warn the reader that, during the synthesis of copolymers having poly (α-methylstyrene) blocks, it is advisable to carefully choose the operating conditions so as to minimize the deactivation of the poly(α-methylstyrene) chains during their stage of synthesis, which makes it possible to minimize the amount of free poly(α-methylstyrene) in the final product. This is because the poly(α-methylstyrene) polymer is described as an impurity which can damage the mechanical properties of the final product.

An ongoing objective of tyre manufacturers is the reduction in the rolling resistance of tyres. The improvement of the rolling resistance presupposes lowering the hysteresis losses. However, the reduction in the hysteresis (and thus the improvement in the hysteresis properties) is not an objective reserved for the field of tyres and can have numerous advantages in other fields using hysteretic materials.

An objective of the invention is thus to reduce the hysteresis of a material based on a thermoplastic elastomer having thermoplastic blocks comprising α-methylstyrene units.

The objective of reducing the hysteresis (of improving the hysteresis properties) is achieved by combining, in certain proportions, a thermoplastic polymer comprising α-methylstyrene units with a triblock thermoplastic elastomer comprising a diene elastomer block and two terminal thermoplastic blocks comprising α-methylstyrene units.

This is because the inventors have been able to demonstrate, contrary to all expectations, that, at the same total content of thermoplastic chains based on α-methylstyrene, a content of more than 10% by weight of a thermoplastic polymer based on α-methylstyrene in an elastomer matrix based on block thermoplastic elastomers, the thermoplastic blocks of which are based on α-methylstyrene, makes it possible to significantly reduce the hysteresis, and thus to improve the hysteresis properties of the elastomer matrix, compared with an elastomer matrix comprising a low content of this thermoplastic polymer.

Thus, a subject-matter of the invention is an elastomer matrix comprising a first polymer which is a block thermoplastic elastomer having a diene elastomer block and two thermoplastic blocks comprising α-methylstyrene units, from 2% to 20% by weight, with respect to the total weight of the elastomer matrix, of a second polymer which is a block thermoplastic elastomer having a diene elastomer block and a thermoplastic block comprising α-methylstyrene units and more than 10% by weight of a third polymer which is a thermoplastic polymer comprising α-methylstyrene units.

### Disclosure of the Invention

A subject-matter of the invention, which invention is described in greater detail below, is at least one of the implementations listed in the following points:
1—An elastomer matrix comprising
   —a triblock thermoplastic elastomer having a central diene elastomer block and two terminal thermoplastic blocks comprising α-methylstyrene units bonded to the diene elastomer block,
   —from 2% to 20% by weight, with respect to the total weight of the elastomer matrix, of a diblock thermoplastic elastomer having a diene elastomer block and a thermoplastic block comprising α-methylstyrene units,
   —more than 10% by weight, with respect to the total weight of the elastomer matrix, of a thermoplastic polymer comprising α-methylstyrene units,
      the content of the thermoplastic blocks of the triblock and diblock thermoplastic elastomers being at least 10% by weight, with respect to the total weight of the triblock and diblock thermoplastic elastomers,
      the content of thermoplastic chains comprising α-methylstyrene units being at most 55% by weight, with respect to the total weight of the elastomer matrix,
      the thermoplastic chains comprising α-methylstyrene units being constituted of the chains of the thermoplastic polymer comprising α-methylstyrene units and of the thermoplastic blocks of the triblock and diblock thermoplastic elastomers.
2—An elastomer matrix according to the preceding implementation, characterized in that it comprises at most 45% by weight of the thermoplastic polymer comprising α-methylstyrene units, with respect to the total weight of the elastomer matrix.
3—An elastomer matrix according to either of the preceding implementations, characterized in that it comprises at least 20% by weight, with respect to the total weight of the elastomer matrix, of thermoplastic chains comprising α-methylstyrene units, preferably at least 25% by weight.
4—An elastomer matrix according to one of the preceding implementations, characterized in that it comprises at least 15% by weight of the thermoplastic polymer comprising α-methylstyrene units, with respect to the total weight of the elastomer matrix.
5—An elastomer matrix according to one of the preceding implementations, characterized in that it comprises predominantly the triblock thermoplastic elastomer having a diene elastomer block and two thermoplastic blocks comprising α-methylstyrene units bonded to the diene elastomer block.
6—An elastomer matrix according to one of the preceding implementations, characterized in that it comprises at most 80% by weight of the triblock thermoplastic elastomer having a diene elastomer block and two thermoplastic blocks comprising α-methylstyrene units bonded to the diene elastomer block, with respect to the total weight of the elastomer matrix.
7—An elastomer matrix according to any one of the preceding implementations, characterized in that the content of the thermoplastic blocks comprising α-methylstyrene units is at least 15% by weight, with respect to the total weight of the triblock and diblock thermoplastic elastomers.
8—An elastomer matrix according to the preceding implementation, characterized in that the content of thermoplastic blocks comprising α-methylstyrene units is at most 45% by weight, preferably 40% by weight, with respect to the total weight of the triblock and diblock thermoplastic elastomers.
9—An elastomer matrix according to one of the preceding implementations, characterized in that it comprises a content of thermoplastic chains comprising α-methylstyrene units of at most 50% by weight, with respect to the total weight of the elastomer matrix.
10—An elastomer matrix according to one of the preceding implementations, characterized in that the diene elastomer blocks comprise units resulting from a diene monomer having from 4 to 12 carbon atoms.
11—An elastomer matrix according to one of the preceding implementations, characterized in that the diene elastomer blocks comprise units resulting from butadiene.
12—An elastomer matrix according to one of the preceding implementations, characterized in that the diene elastomer blocks additionally comprise units resulting from a vinylaromatic monomer.
13—An elastomer matrix according to the preceding implementation, characterized in that the vinylaromatic monomer is styrene.
14—An elastomer matrix according to one of the preceding implementations, characterized in that the diene elastomer blocks are completely or partially hydrogenated.
15—An elastomer matrix according to one of the preceding implementations, characterized in that the thermoplastic blocks comprising α-methylstyrene units predominately comprise units resulting from α-methylstyrene.
16—An elastomer matrix according to the preceding implementation, characterized in that the thermoplastic blocks comprising α-methylstyrene units additionally comprise units resulting from at least one other vinylaromatic monomer, preferably styrene.
17—An elastomer matrix according to one of Implementations 1 to 15, characterized in that the thermoplastic blocks comprising α-methylstyrene units are essentially constituted of α-methylstyrene units.
18—An elastomer matrix according to one of the preceding implementations, characterized in that the thermoplastic polymer comprising α-methylstyrene units predominately comprises units resulting from α-methylstyrene.
19—An elastomer matrix according to one of the preceding implementations, characterized in that the thermoplastic polymer comprising α-methylstyrene units comprises units resulting from at least one other vinylaromatic monomer, preferably styrene.
20—An elastomer matrix according to one of Implementations 1 to 18, characterized in that the thermoplastic polymer comprising α-methylstyrene units is an α-methylstyrene homopolymer.
21—An elastomer matrix according to one of the preceding implementations, characterized in that at least one of the following characteristics is observed, preferably two, preferably three, preferably four, preferably five, preferably all,
   the diene blocks of the triblock and diblock thermoplastic elastomers comprise units resulting from butadiene,
   the thermoplastic blocks of the triblock and diblock thermoplastic elastomers are constituted of poly (α-methylstyrene),
   the thermoplastic polymer comprising α-methylstyrene units is a poly (α-methylstyrene),
   the content of thermoplastic blocks of the triblock and diblock thermoplastic elastomers comprising α-methylstyrene units is at least 10% by weight and at most 45% by weight, with respect to the total weight of the triblock thermoplastic elastomer and of the diblock thermoplastic elastomer,
   the matrix comprises more than 10% by weight, preferably at least 15% by weight, and at most 45% by weight, with respect to the total weight of the elastomer matrix, of a thermoplastic polymer comprising α-methylstyrene units,
   the content of thermoplastic chains comprising α-methylstyrene units is at least 20% by weight and at most 55% by weight, with respect to the total weight of the elastomer matrix.

### Definitions

In the present document, unless expressly indicated otherwise, all the percentages (%) indicated are percentages (%) by weight.

Furthermore, any interval of values denoted by the expression “between a and b” represents the range inside the limits a and b (that is to say, limits a and b excluded), whereas any interval of values denoted by the expression “from a to b” means the range of values extending from a up to b (that is to say, including the strict limits a and b).

In the present patent application, “predominantly” or “predominant”, in connection with a compound, is understood to mean that this compound is predominant among the compounds of the same type in a composition, that is to say that it is that which represents the largest fraction by weight among the compounds of the same type. Thus, a unit resulting from a “predominant” monomer in a polymer is that representing the largest fraction by weight among the units constituting the polymer, with respect to the total weight of said polymer. Alternatively, a component is “predominant” in a composition when it represents the largest fraction by weight among the components constituting the composition, with respect to the total weight of said composition. In a system comprising just one element of a certain type, the latter is predominant within the meaning of the present invention.

In the present patent application, “elastomer matrix” is understood to mean a mixture constituted of polymers and exhibiting elastomeric properties.

Poly(α-methylstyrene) is commonly understood to mean an α-methylstyrene homopolymer.

In the present patent application, “thermoplastic chains comprising α-methylstyrene units” is understood to mean the chains of the thermoplastic polymer comprising α-methylstyrene units and of the thermoplastic blocks comprising α-methylstyrene units of the triblock and diblock thermoplastic elastomers.

The carbon-comprising compounds mentioned in the description can be of fossil origin or be biobased. In the latter case, they can result, partially or completely, from biomass or be obtained, partially or completely, from renewable starting materials resulting from biomass. In the same way, the compounds mentioned can also originate from the recycling of pre-used materials, that is to say that they can, partially or completely, result from a recycling process, or else be obtained, partially or completely, from starting materials themselves resulting from a recycling process. The monomers, the polymers, and the like, are concerned in particular.

### DETAILED DESCRIPTION OF THE INVENTION

The invention relates to an elastomer matrix comprising:
a triblock thermoplastic elastomer having a central diene elastomer block and two terminal thermoplastic blocks comprising α-methylstyrene units bonded to the diene elastomer block,
from 2% to 20% by weight, with respect to the total weight of the elastomer matrix, of a diblock thermoplastic elastomer having a diene elastomer block and a thermoplastic block comprising α-methylstyrene units,
more than 10% by weight, with respect to the total weight of the elastomer matrix, of a thermoplastic polymer comprising α-methylstyrene units,
   the content of thermoplastic blocks of the triblock and diblock thermoplastic elastomers being at least 10% by weight, with respect to the total weight of the triblock and diblock thermoplastic elastomers,
   the content of thermoplastic chains comprising α-methylstyrene units being at most 55% by weight, with respect to the total weight of the elastomer matrix,
   the thermoplastic chains comprising α-methylstyrene units being constituted of the chains of the thermoplastic polymer comprising α-methylstyrene units and of the thermoplastic blocks comprising α-methylstyrene units of the triblock and diblock thermoplastic elastomers.

### A—The Elastomer Matrix

Within the elastomer matrix, the combination of the characteristics relating to the contents of block thermoplastic elastomer and of thermoplastic polymer, to the content of thermoplastic blocks and to the content of thermoplastic chains makes it possible to bring together the elastomeric properties and the thermoplastic character of the matrix, while making it possible to achieve a significant decrease in the hysteresis compared with a matrix comprising one and the same total content of thermoplastic chains but less thermoplastic polymer.

According to the invention, the elastomer matrix comprises a triblock thermoplastic elastomer having a central diene elastomer block and two terminal thermoplastic blocks bonded to the diene elastomer block comprising α-methylstyrene units.

The minimum content of the triblock thermoplastic elastomer in the elastomer matrix is determined by the properties associated with the diene elastomer block. The elastomer matrix must have an elastomeric character. According to certain embodiments of the invention, the triblock thermoplastic elastomer is the predominant component by weight of the elastomer matrix, that is to say that the fraction by weight of the triblock thermoplastic elastomer is the largest among those of the polymers making up the matrix. According to these embodiments, the triblock thermoplastic elastomer can be present in the elastomer matrix in proportions of at least 50% by weight, with respect to the total weight of the elastomer matrix, preferably of at least 65% by weight. The content of the triblock thermoplastic elastomer is at most 88% by weight of the total weight of the elastomer matrix. According to certain embodiments, this content is advantageously at most 80% by weight of the total weight of the elastomer matrix.

According to the invention, the elastomer matrix also comprises from 2% to 20% by weight of the total weight of the elastomer matrix of a diblock polymer composed of a diene elastomer block and of a thermoplastic block comprising α-methylstyrene units.

According to the invention, in the elastomer matrix, the thermoplastic blocks of these block elastomers comprising α-methylstyrene units represent at least 10% by weight, with respect to the total weight of the triblock and diblock thermoplastic elastomers. The thermoplastic polymer comprising α-methylstyrene units, which is another component of the elastomer matrix, is not regarded as a thermoplastic block according to the invention. In other words, according to the invention, the thermoplastic blocks comprising α-methylstyrene units represent at least 10% by weight, with respect to the weight of the block polymers of the matrix.

Preferentially, the thermoplastic blocks comprising α-methylstyrene units represent at most 45% by weight, more preferably at most 40% by weight, with respect to the total weight of the triblock and diblock thermoplastic elastomers. Above 45% by weight, the elastomeric character of the thermoplastic elastomers which can be used according to the invention may be degraded.

According to the invention, the elastomer matrix also comprises a thermoplastic polymer comprising α-methylstyrene units in proportions of more than 10% by weight, with respect to the total weight of the elastomer matrix. Above 10% by weight of thermoplastic polymer comprising α-methylstyrene units, an improvement in the hysteresis properties is observed, with respect to a matrix comprising the same content of thermoplastic chains but less than 10% by weight of thermoplastic polymer comprising α-methylstyrene units.

According to one embodiment of the invention, the elastomer matrix comprises at most 45% by weight, with respect to the total weight of the elastomer matrix, of thermoplastic polymer comprising α-methylstyrene units. This is because a person skilled in the art will understand that the matrix according to the invention exhibits elastomeric properties and, above 45% by weight, the compromise in properties associated with this elastomeric nature deteriorates.

According to a particular embodiment of the invention, the elastomer matrix comprises at least 15% by weight, with respect to the total weight of the elastomer matrix, of a thermoplastic polymer comprising α-methylstyrene units.

According to a particular embodiment of the invention, the content of thermoplastic polymer comprising α-methylstyrene units in the elastomer matrix is more than 10% by weight, in particular at least 15% by weight, and at most 45% by weight, with respect to the total weight of the elastomer matrix.

The elastomer matrix according to the invention comprises a content of thermoplastic chains comprising α-methylstyrene units of at most 55% by weight, preferably of at most 50% by weight, with respect to the total weight of the elastomer matrix. “Thermoplastic chains comprising α-methylstyrene units” is understood to mean all of the thermoplastic chains constituted of the chains of the thermoplastic polymer comprising α-methylstyrene units and of the thermoplastic blocks comprising α-methylstyrene units of the triblock and diblock thermoplastic elastomers. Above 55% by weight, the elastomeric character of the matrix may be degraded, and also the properties associated with elasticity.

According to embodiments of the invention, the elastomer matrix according to the invention exhibits a content of thermoplastic chains comprising α-methylstyrene units of at least 20% by weight, with respect to the total weight of the elastomer matrix. According to some of these embodiments, the content of thermoplastic chains comprising α-methylstyrene units can be at least 25% by weight, with respect to the total weight of the elastomer matrix.

### B—The Block Polymers

The triblock thermoplastic elastomer and the diblock thermoplastic elastomer of the elastomer matrix according to the invention are composed respectively of three and two polymer blocks. The triblock thermoplastic elastomer has a central diene elastomer block. The diblock thermoplastic elastomer has a diene elastomer block which can be of the same nature as that of the triblock thermoplastic elastomer.

Diene elastomer is understood to mean an elastomer resulting, at least in part (i.e., a homopolymer or a copolymer), from diene monomers (monomers bearing two conjugated or non-conjugated carbon-carbon double bonds).

According to a preferred embodiment of the invention, diene elastomer is understood to mean any homopolymer obtained by polymerization of a conjugated diene monomer having from 4 to 12 carbon atoms or any copolymer obtained by copolymerization of one or more conjugated dienes having from 4 to 12 carbon atoms with one another or with one or more vinylaromatic compounds having from 8 to 20 carbon atoms.

The following are suitable in particular as conjugated dienes which can be used in accordance with the invention: 1,3-butadiene, 2-methyl-1,3-butadiene (isoprene), 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene and 2,4-hexadiene.

According to one embodiment of the invention, the diene elastomer comprises units resulting from 1,3-diene monomer having from 4 to 12 carbon atoms; more particularly, the diene elastomer comprises units resulting from butadiene or from isoprene.

The following are suitable in particular as vinylaromatic compounds: styrene, α-methylstyrene, ortho-, meta- or parα-methylstyrene, the “vinyltoluene” commercial mixture, para-(tert-butyl)styrene, methoxystyrenes, vinylmesitylene, divinylbenzene and vinylnaphthalene.

According to one embodiment of the invention, the diene elastomer additionally comprises units resulting from a vinylaromatic monomer, more particularly styrene.

The diene elastomer is preferentially a polybutadiene (BR), a synthetic polyisoprene (IR), a butadiene copolymer, in particular a copolymer of butadiene and of a vinylaromatic monomer, in particular styrene, or an isoprene copolymer. According to one embodiment, the diene elastomer is a polybutadiene or a butadiene copolymer.

The diene elastomer can have any microstructure which depends on the polymerization conditions used. The diene elastomer can also be coupled or star-branched by means of a coupling or star-branching agent bearing or not bearing a functional group.

According to one embodiment of the invention, the diene elastomer constituting the central block of the thermoplastic elastomer is completely or partially hydrogenated. A partial hydrogenation is usually preferred when a subsequent crosslinking of the thermoplastic elastomer is envisaged by means of the carbon-carbon double bonds of the elastomer. A complete hydrogenation can also be envisaged in the light of in particular the formation of rigid nodules, formed by zones of association of thermoplastic blocks with one another, playing the role of crosslinking nodes.

Preferably, for the invention, the diene elastomer block of the thermoplastic elastomer exhibits, all in all, a number-average molar mass (Mₙ) of at least 25 000 g/mol, preferably of at least 35 000 g/mol, and of at most 350 000 g/mol, preferably of at most 250 000 g/mol, so as to confer, on the thermoplastic elastomers, good elastomeric properties and a satisfactory mechanical strength. The number-average molar mass of the diene elastomer block of the thermoplastic elastomer can be determined by size exclusion chromatography in a way known to a person skilled in the art using a calibration curve produced from diene standards.

According to particular embodiments, the diene elastomer block of the triblock thermoplastic elastomer and the diene elastomer block of the diblock thermoplastic elastomer are of the same nature. That is to say that they have the same microstructure and the same macrostructure.

The thermoplastic elastomer of the elastomer matrix according to the invention comprises two terminal thermoplastic blocks comprising α-methylstyrene units.

In the context of the invention, thermoplastic block comprising α-methylstyrene units is understood to mean a thermoplastic block comprising units resulting from α-methylstyrene and having a glass transition temperature of greater than or equal to 100° C., preferably of at least 120° C., and of at most 180° C. The Tg of the thermoplastic blocks is measured according to the method described below.

Preferably, the thermoplastic blocks of the thermoplastic elastomers exhibit, all in all, a number-average molar mass (Mₙ) of at least 5000 g/mol, preferably of at least 7000 g/mol, and of at most 100 000 g/mol, preferably of at most 50 000 g/mol. The number-average molar mass of the thermoplastic block of the thermoplastic elastomer can be determined by size exclusion chromatography in a way known to a person skilled in the art and expressed here relative to polystyrene standards.

According to preferential embodiments of the invention, the thermoplastic blocks comprising α-methylstyrene units of the thermoplastic elastomer predominantly comprise units resulting from α-methylstyrene in order to impart good thermal resistance to the thermoplastic elastomer, and also to the elastomer matrix. In other words, according to this embodiment, each thermoplastic block preferably comprises at least 50% by weight, preferably at least 70% by weight, of units resulting from the α-methylstyrene monomer.

When the thermoplastic blocks comprising α-methylstyrene units of the thermoplastic elastomer additionally comprise units resulting from at least one other monomer, the latter can be vinylaromatic, preferably styrene.

According to particularly advantageous embodiments, the thermoplastic blocks of the thermoplastic elastomer are essentially constituted of α-methylstyrene units, that is to say that the thermoplastic blocks do not comprise units resulting from a monomer other than α-methylstyrene. Thus, a better thermal resistance at higher temperature of the thermoplastic elastomer, and also of the elastomer matrix, is observed.

The minimum content of thermoplastic blocks in the thermoplastic elastomers can vary as a function of the conditions of use of the thermoplastic elastomers.

On the other hand, the ability of the thermoplastic elastomers to deform during the manufacture of an object can also contribute to determining the proportion of the thermoplastic blocks in the thermoplastic elastomers which can be used according to the invention.

According to the invention, the thermoplastic blocks comprising α-methylstyrene units represent at least 10% by weight, with respect to the total weight of the triblock and diblock thermoplastic elastomers of the elastomer matrix. According to certain embodiments of the invention, the thermoplastic blocks comprising α-methylstyrene units represent at least 15% by weight, with respect to the total weight of the triblock and diblock thermoplastic elastomers of the elastomer matrix.

According to one embodiment of the invention, the thermoplastic blocks comprising α-methylstyrene units represent at most 45% by weight, preferably at most 40% by weight, with respect to the total weight of the triblock and diblock thermoplastic elastomers of the elastomer matrix.

The triblock thermoplastic elastomer and the diblock thermoplastic elastomer in accordance with the invention can be manufactured in a known way according to various methods of synthesis described in the prior art.

One method of synthesis of a triblock thermoplastic elastomer consists, for example, in anionically polymerizing α-methylstyrene in order to form the two thermoplastic blocks simultaneously in the presence of polydienyldilithium as polymerization initiator. For example, WO 8505116A1 and EP 0 014 947 A1 describe such methods which comprise the copolymerization of styrene and of α-methylstyrene to generate thermoplastic blocks. A triblock copolymer of poly (α-methylstyrene-co-styrene)-b-polydiene-b-poly (α-methylstyrene-co-styrene) type is thus obtained. Analogous methods of synthesis can be envisaged to manufacture poly(α-methylstyrene)-b-polydiene-poly(α-methylstyrene) triblock polymers using a polydienyllithium as polymerization initiator. Such a process is, for example, described in FR 3 045 615.

Another method of synthesis consists in anionically polymerizing α-methylstyrene in a first step. Then, in a second stage, the diene monomer is polymerized on the living chains obtained comprising α-methylstyrene units. A (thermoplastic comprising α-methylstyrene units)-b-polydiene diblock polymer, the dienyl end of which is living, is thus obtained. The polymerization reaction can be stopped conventionally at this point by the addition of a protic compound, and then a diblock diene elastomer can be recovered.

Alternatively, according to this other method of synthesis, for the purpose of obtaining a triblock thermoplastic elastomer, a coupling agent is added at this point to couple the dienyl blocks of the chains, the dienyl ends of which are reactive. This stage is carried out in a way known per se. The coupling agents generally contain a silicon or tin atom, substituted by at least two groups which are reactive with respect to the carbanion end of the living polymer chains. Mention may be made, by way of example of coupling agents, of those having two reactive groups, such as dihalotin compounds and dihalosilane compounds, in particular dibutyltin dichloride or dimethyldichlorosilane, or also dialkoxysilanes. On conclusion of this coupling stage, a (thermoplastic comprising α-methylstyrene units)-b-polydiene-b-(thermoplastic comprising α-methylstyrene units) triblock is formed.

A person skilled in the art will understand that, depending on the operating conditions according to this last method of synthesis, the process can result in a product consisting of a mixture, besides (thermoplastic comprising α-methylstyrene units)-b-diene elastomer-b-(thermoplastic comprising α-methylstyrene units) triblock, of other populations of macromolecules, such as thermoplastic polymers comprising α-methylstyrene units and (thermoplastic comprising α-methylstyrene units)-b-diene elastomer diblock polymers. A person skilled in the art knows how to determine the conditions of synthesis in order to promote the formation of certain populations rather than of others. For example, a person skilled in the art can, by modulating in particular the amount and the nature of the coupling agent, achieve the targeted contents of triblock thermoplastic elastomer and of diblock thermoplastic elastomer respectively.

Such processes for the synthesis of block thermoplastic elastomers are described, for example, in U.S. Pat. No 4,302,559 A. The synthesis of the block copolymer comprises a first stage of polymerization of α-methylstyrene at low temperature in the presence of a polar agent. In a second stage, a small amount of conjugated diene is added in order to obtain a living polydienyl block to avoid the depolymerization of the α-methylstyrene. In a third stage, in the presence of another polar compound, the addition of conjugated diene monomer makes it possible to insert the residual α-methylstyrene randomly. To obtain a triblock copolymer, the polymer resulting from the last polymerization stage is coupled using a coupling agent. The central diene elastomer block of the triblock copolymer is, according to this method of synthesis, a random poly(butadiene-co-α-methylstyrene) copolymer.

Other processes employing this method of synthesis of a poly (α-methylstyrene)-b-polydiene-b-poly(α-methylstyrene) triblock copolymer are described which make it possible to obtain a central diene elastomer block devoid of α-methylstyrene. For example, in the document FR 2 243 214, the process consists, in a first stage, in homopolymerizing the α-methylstyrene in concentrated medium at temperatures between 0° C. and 40° C. On conclusion of this stage, the conjugated diene and the solvent which are necessary for the synthesis of the poly (conjugated diene) block are added. On conclusion of this last polymerization stage, the polymer obtained is coupled using a coupling agent. More recently, WO 2020070406A1 describes another process which makes possible the synthesis of a poly (α-methylstyrene)-b-polydiene-b-poly(α-methylstyrene) triblock copolymer, the central diene elastomer block of which is also devoid of α-methylstyrene.

In the context of the invention, the elastomer matrix can comprise one or more triblock thermoplastic elastomers having a central diene elastomer block and two terminal thermoplastic blocks comprising α-methylstyrene units. In the same way, the elastomer matrix can comprise from 2% to 20% by weight of one or more diblock thermoplastic elastomers having a diene elastomer block and a thermoplastic block comprising α-methylstyrene units.

### C—The Thermoplastic Polymer Comprising α-Methylstyrene Units

In the elastomer matrix according to the invention, the thermoplastic polymer comprising α-methylstyrene units can be of the same nature as or of a different nature from the terminal thermoplastic blocks of the triblock thermoplastic elastomer.

The thermoplastic polymer comprising α-methylstyrene units can additionally comprise units resulting from at least one other monomer provided that the polymer retains its thermoplastic behaviour. This other monomer can be a vinylaromatic monomer as defined above. According to this embodiment of the invention, the other monomer is preferably styrene.

According to a preferential embodiment, the thermoplastic polymer comprises predominantly units resulting from α-methylstyrene in order to impart good thermal resistance to the elastomer matrix according to the invention. According to this embodiment, the thermoplastic polymer preferably comprises at least 50% by weight, preferably at least 70% by weight, of units resulting from the α-methylstyrene monomer. More particularly, according to this embodiment, the thermoplastic polymer is advantageously an α-methylstyrene homopolymer.

Preferably, the thermoplastic polymer comprising α-methylstyrene units exhibits a number- average molar mass (Mₙ) of at least 5000 g/mol and at most 150 000 g/mol, preferably at most 100 000 g/mol, more preferentially at most 50 000 g/mol. The number-average molar mass of the thermoplastic polymer can be measured by size exclusion chromatography in a way known to a person skilled in the art using a calibration curve produced from polystyrene standards.

In the context of the invention, the thermoplastic polymer comprising α-methylstyrene units exhibits a glass transition temperature of greater than or equal to 100° C., preferably of at least 120° C., and of at most 180° C. The Tg of the thermoplastic polymer is measured according to the method described below.

The thermoplastic polymer comprising α-methylstyrene units is commercially available or can be manufactured in a known way, for example by anionic polymerization of α-methylstyrene in the presence of an organometallic polymerization initiator, for example an organolithium compound, such as an alkyllithium. The document FR 2 852 960 A1 describes a method of synthesis of poly(α-methylstyrene).

Mention may be made, as commercially available thermoplastic polymer comprising α-methylstyrene units, of that sold by ABCR.

In the context of the invention, the elastomer matrix can comprise one or more different thermoplastic polymers comprising α-methylstyrene units.

The various preferential or non-preferential embodiments of the invention, relating to the block polymers and to the thermoplastic polymer, can be combined with one another.

Thus, according to a particularly advantageous embodiment of the invention, the elastomer matrix exhibits at least one of the following characteristics, preferably two, preferably three, preferably four, preferably five, preferably six, preferably all,
the diene blocks of the triblock and diblock thermoplastic elastomers comprise units resulting from butadiene,
the thermoplastic blocks of the triblock and diblock thermoplastic elastomers are constituted of poly (α-methylstyrene),
the thermoplastic polymer comprising α-methylstyrene units is a poly(α-methylstyrene),
the content of thermoplastic blocks of the triblock and diblock thermoplastic elastomers comprising α-methylstyrene units is at least 10% by weight and at most 45% by weight, with respect to the total weight of the triblock thermoplastic elastomer and of the diblock thermoplastic elastomer,
the matrix comprises more than 10% by weight, preferably at least 15% by weight, and at most 45% by weight, with respect to the total weight of the elastomer matrix, of a thermoplastic polymer comprising α-methylstyrene units,
the content of thermoplastic chains comprising α-methylstyrene units is at least 20% by weight and at most 55% by weight, with respect to the total weight of the elastomer matrix.

### D—Preparation of the Elastomer Matrix

According to one embodiment, the elastomer matrix of the invention can be obtained by compounding, in solution, of the triblock thermoplastic elastomer, of the diblock thermoplastic elastomer and of the thermoplastic polymer comprising α-methylstyrene units, each obtained separately. According to another embodiment, the mixture of the triblock thermoplastic elastomer and of the diblock thermoplastic elastomer is obtained during a single process of synthesis as explained above. This mixture of diblock and triblock thermoplastic elastomers is subsequently mixed with the thermoplastic polymer comprising α-methylstyrene units. According to yet another embodiment, the elastomer matrix according to the invention can be obtained during a one-pot synthesis process consisting in anionically polymerizing α-methylstyrene in a first step. The polymerization of a portion of the chains is conventionally stopped at this point by the addition of a protic compound to generate the thermoplastic polymer, the content of which is controlled by adjusting the amount of protic agent. The synthesis is continued as explained above to subsequently form the diblock and triblock thermoplastic elastomers.

According to any one of these embodiments, the polymers can be dissolved together in a common solvent.

Alternatively, according to any one of these embodiments, the polymers can be dissolved separately in solvents which are identical or different but miscible with one another, and the compounding of the solutions is subsequently carried out.

Mention may be made, as solvent, of any inert hydrocarbon solvent, which can, for example, be an aliphatic or alicyclic hydrocarbon, such as pentane, hexane, heptane, isooctane, cyclohexane or methylcyclohexane, or an aromatic hydrocarbon, such as benzene, toluene or xylene.

Once compounding is complete, the solvent can be removed, for example by stripping. At this point, the elastomer matrix can subsequently be dried and recovered.

The elastomer matrix according to the invention can be used in compositions with one or more other compounds. The advantage created by thermoplastic elastomers and also the improved hysteresis properties of the elastomer matrix according to the invention make it possible to envisage use in numerous fields. Mention may in particular be made of use in the manufacture of various rubber-based products, such as hoses, belts, tyres, tracks, footwear soles, surgical articles, and the like.

### EXAMPLES

### I. Description of the Measurement Methods

A—Proton Nuclear Magnetic Resonance (¹H NMR) for the Measurement of the Poly(α-methylstyrene) Content in Products Resulting From the Synthesis of Block Thermoplastic Elastomers and in Elastomer Matrices

The spectral characterization and the measurements of the microstructure of polymers are carried out by liquid-phase Nuclear Magnetic Resonance (NMR) spectroscopy. Proton NMR makes it possible to distinguish and to quantify the 1,2-butadiene, 1,4-butadiene and α-methylstyrene units of the elastomer matrix. For these measurements, a Bruker Avance III HD ≥400 MHz spectrometer is used, equipped with a Bruker BBFO z-grad 5 mm cryoprobe.

The 1D ¹H NMR experiments are recorded using a radiofrequency pulse with a tilt angle of 30°, the number of repetitions is 64 with a recycle delay of 5 seconds. The experiments are carried out at 25° C.

The preparation of the NMR tubes is carried out so that 25 mg of sample are dissolved in 1 ml of CS₂ with addition of 100 μl of C₆D₁₂. The axis of the ¹H chemical shifts is calibrated with respect to the signal of the impurity of the solvent CS₂ used at δ_{1H}=7.18 ppm.

The quantification of the microstructure is carried out in molar percentage (molar %) and in percentage by weight (% by weight) from the integration of the 1D ¹H NMR spectra with the help of the Topspin software using calculations known to a person skilled in the art. The integration zones considered for the quantification are spectral signature zones of the monomer units known to a person skilled in the art. The amount of thermoplastic chains comprising α-methylstyrene units is determined from these calculations.

### B—Size Exclusion Chromatography (SEC):

### Measurement of the Molar Mass of the Samples

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to understand the distribution of the molar masses of a polymer. Starting from commercial standard products, the various number-average molar masses (Mₙ) and weight-average molar masses (M_{w}), and also the peak molar mass (Mₚ), can be determined and the polydispersity index (PI=M_{w}/Mₙ) calculated via a “Moore” calibration.

There is no particular treatment of the polymer sample before analysis. The latter is simply dissolved in the elution solvent at a concentration of approximately 1 g·l⁻¹. The solution is then filtered through a filter with a porosity of 0.45 μm before injection.

The apparatus used is a Waters Alliance chromatographic line. The elution solvent is either tetrahydrofuran, protected from oxidation with 250 ppm of BHT (butylated hydroxytoluene), or tetrahydrofuran without antioxidant, the flow rate is 1 ml·min⁻¹, the temperature of the system is 35° C. and the analytical time is 45 min. The columns used are either a set of three Agilent columns of Polypore trade name or a set of four Agilent columns, two of PL Gel Mixed D trade name and two of PL Gel Mixed E trade name. The injected volume of the solution of the polymer sample is 100 μl. The detector is a Waters 2410 differential refractometer (RI) and the software for making use of the chromatographic data is the Waters Empower system.

The calculated number-average molar masses are relative to a calibration curve produced from commercial “PSS-pskit1h-3” polystyrene standards in the case of the thermoplastic polymers comprising α-methylstyrene units alone.

The calculated number-average molar masses are relative to a calibration curve produced from commercial “PSS-bdfkit” polybutadiene standards in the case of products comprising diblock and/or triblock thermoplastic elastomers containing butadiene units.

In the case of the products resulting from the synthesis of the block thermoplastic elastomers (thermoplastic block comprising α-methylstyrene units-b-polydiene-b-thermoplastic block comprising α-methylstyrene units) containing less than 10% by weight of thermoplastic polymer comprising poly (α-methylstyrene) units, the distribution of the different entities of the product is produced from the integration of the RI signal of the SEC chromatograms. The proportion by weight of each entity is related to the integral of all of the RI signals of the chromatogram.

In the case of the products containing more than 10% by weight of thermoplastic polymer comprising poly (α-methylstyrene) units, the distribution of the different entities of the product is produced from the integration of the RI signal of the SEC chromatograms while modulating the RI response by the value of the specific increment in the refractive index dn/dc of each entity or while producing a calibration straight line by metred addition of thermoplastic polymer comprising poly(α-methylstyrene) units, in a way known to a person skilled in the art.

### C—Composition of the Elastomer Matrices

### C-1 The Contents of Thermoplastic Polymer Comprising α-Methylstyrene Units and of Block Polymers are Determined by RI SEC as Described Above

In the case of the addition of thermoplastic polymer comprising α-methylstyrene units to a thermoplastic elastomer, the amount of thermoplastic polymer comprising α-methylstyrene units present in the elastomer matrix can be calculated by adding the amount contained in the mixture resulting from the synthesis of the thermoplastic elastomer, and determined by RI SEC, and the amount of thermoplastic polymer added, according to calculations known to a person skilled in the art.

### C—2 The Content of Thermoplastic Chains Comprising α-Methylstyrene Units is Determined by NMR as Described Above

### C—3 The Content of Thermoplastic Block Comprising α-Methylstyrene Units

The content of thermoplastic block comprising α-methylstyrene units is calculated in the following way:

Content of thermoplastic block comprising α-methylstyrene units=(content of thermoplastic chains comprising α-methylstyrene units−content of thermoplastic polymer comprising α-methylstyrene units)*100/(100−content of thermoplastic polymer comprising α-methylstyrene units)

### D—Measurement of the Tg of the Thermoplastic Blocks Comprising α-Methylstyrene Units and of the Thermoplastic Polymers Comprising α-Methylstyrene Units

### D-1 Blocks of the Thermoplastic Elastomers

The characterization of the Tg values of the thermoplastic elastomers (of the elastomer block and of the thermoplastic blocks comprising α-methylstyrene units) is carried out by a DSC measurement (Netzsch DSC214 Polyma appliance). The appliance operates under a helium atmosphere. A sample of 10 to 20 mg of thermoplastic elastomer is withdrawn and deposited in a crucible conventionally used by a person skilled in the art to carry out Tg measurements.

The sample is first placed under isothermal conditions at +25° C. for 2 minutes and then cooled to −100° C. at a rate of 50° C. per minute. An isotherm is then applied at −100° C. for 5 minutes. A first heating then begins from −100° C. to +10° C. at the rate of 20° C. per minute and continues from 10° C. to 250° C. at the rate of 50° C. per minute. The sample is then subjected to quenching to reach −100° C. at the maximum speed allowed by the appliance. The sample is then maintained under isothermal conditions at −100° C. for 5 minutes. The second heating then begins from −100° C. to +10° C. at the rate of 20° C. per minute (range of measurement of the Tg of the elastomer block) and continues from +10° C. to +250° C. at the rate of 50° C. per minute (range of measurement of the Tg of the thermoplastic blocks comprising α-methylstyrene units). In this measurement, only the second heating is made use of.

### D—2 Thermoplastic Polymers Comprising α-Methylstyrene Units

The characterization of the Tg values of the thermoplastic polymers comprising α-methylstyrene units is carried out by a DSC measurement (Netzsch DSC214 Polyma appliance). The appliance operates under a helium atmosphere. A sample of 10 to 20 mg of TPE elastomer is withdrawn and deposited in a crucible conventionally used by a person skilled in the art to carry out Tg measurements.

The sample is first placed under isothermal conditions at +10° C. for 2 minutes. A first heating then begins from 10° C. to +250° C. at the rate of 50° C. per minute. The sample then undergoes cooling from 250° C. to 10° C. at the rate of 30° C. per minute. The sample is then maintained under isothermal conditions at 10° C. for 2 minutes. The second heating then begins from 10° C. to 250° C. at the rate of 50° C. per minute. In this measurement, only the second heating is made use of.

### E-Hysteresis Properties

Tan δ max is measured on a viscosity analyser (Metravib VA4000) according to Standard ASTM D 5992-96. The response of a sample of the elastomer matrix pre-moulded in a way known to a person skilled in the art (cylindrical test specimen with a thickness of 2 mm and a cross section of 79 mm²), subjected to a simple alternating sinusoidal shear stress, at a frequency of 10 Hz, at 60° C., according to Standard ASTM D 1349-99, is recorded. A strain amplitude sweep is carried out from 0.1% to 50% peak-to-peak (outward cycle) and then from 50% to 0.1% peak-to-peak (return cycle). The result more particularly made use of is the loss factor tan δ. For the return cycle, the maximum value of tan δ observed, denoted tan δ max, is indicated. This value is representative of the hysteresis of the material: the smaller the value of tan δ max, the lower the hysteresis of the matrix.

### II. Synthesis of the Polymers and Preparation of the Elastomer Matrices

In the tests which follow, the following names will be adopted:
poly(α-methylstyrene)=PAMS
bonded poly(α-methylstyrene)=bonded PAMS=thermoplastic blocks comprising α-methylstyrene units of the block polymers
total poly(α-methylstyrene)=total PAMS=thermoplastic chains comprising α-methylstyrene units
free poly(α-methylstyrene)=free PAMS=thermoplastic polymer comprising α-methylstyrene units
   A—Synthesis of a Poly(α-methylstyrene)-b-polybutadiene-b-poly(α-methylstyrene) Triblock Polymer A Having 15% by Weight of Total Poly(α-methylstyrene):

3.46 kg of methylcyclohexane, 2 kg of α-methylstyrene and 0.25 mol of tetrahydrofurfuryl ethyl ether are introduced into an 80 litre reactor. After neutralization of the impurities with n-butyllithium, 0.05 mol of s-butyllithium is introduced. After 2 h 55 min at T=5° C., the conversion of α-methylstyrene, measured by solids content, is 50%. Analysis of the polymer by size exclusion chromatography shows the presence of a single population: Mₙ=18 100 g/mol. The Tg, measured by DSC, is 139° C.

At the end of these 2 h 55 min at 5° C., 33.1 kg of methylcyclohexane, the impurities of which have been pre-neutralized with n-butyllithium, are introduced into the reactor and then 5.7 kg of butadiene are introduced by means of a pump at a flow rate of 13 kg/h. The reaction medium is maintained at 5° C. At the end of the 26 minutes requiring the introduction of the 5.7 kg of butadiene, the medium is maintained at 5° C. for 80 additional minutes. The butadiene conversion at the end of these 106 minutes at 5° C. is 96%. Analysis of the polymer by size exclusion chromatography shows the presence of two populations: M_{n,1}=13 800 g/mol (2%), corresponding to free PAMS, and M_{n,2}=114 100 g/mol (98%), corresponding to PAMS-b-polybutadiene diblock.

0.024 mol of dimethyldichlorosilane is subsequently introduced into the reactor. The reaction medium is maintained at 5° C. for 12 minutes. The polymer obtained on conclusion of this coupling stage is a poly(α-methylstyrene)-b-polybutadiene-b-poly(α-methylstyrene) triblock polymer which exhibits three populations by SEC analysis:
M_{n,1}=12 000 g/mol (2%), corresponding to free PAMS,
M_{n,2}=101 000 (14%), corresponding to PAMS-b-polybutadiene diblock, and
M_{n,3}=229 000 (83%), corresponding to the PAMS-b-polybutadiene-b-PAMS triblock.

The content by weight of total poly(α-methylstyrene) chains in the final sample, measured by NMR, is 15%.

The content by weight of bonded poly(α-methylstyrene) block, with respect to the total weight of diblock and of triblock in the final sample, is 13%.

The dry polymer is recovered by stripping and then drying in an oven.

B-Synthesis of a Poly(α-methylstyrene)-b-polybutadiene-b-poly(α-methylstyrene) Triblock Polymer B Having 28% by Weight of Total Poly(α-methylstyrene):

5 kg of methylcyclohexane, 3 kg of α-methylstyrene and 0.375 mol of tetrahydrofurfuryl ethyl ether are introduced into an 80 litre reactor. After neutralization of the impurities with n-butyllithium, 0.075 mol of s-butyllithium is introduced. After 2 h 20 min at T=5° C., the conversion of α-methylstyrene, measured by solids content, is 51%. Analysis of the polymer by size exclusion chromatography shows the presence of a single population: Mₙ=18 500 g/mol. The Tg, measured by DSC, is 155° C.

At the end of these 2 h 20 min at 5° C., 33.6 kg of methylcyclohexane, the impurities of which have been pre-neutralized with n-butyllithium, are introduced into the reactor and then 6 kg of butadiene are introduced by means of a pump at a flow rate of 13 kg/h. The reaction medium is maintained at 5° C. At the end of the 28 minutes requiring the introduction of the 6 kg of butadiene, the medium is maintained at 5° C. for 5 additional minutes. The butadiene conversion at the end of these 33 minutes at 5° C. is 79%. Analysis of the polymer by size exclusion chromatography shows the presence of two populations: M_{n,1}=10 800 g/mol (2%), corresponding to free PAMS, and M_{n,2}=53 800 g/mol (98%), corresponding to PAMS-b-polybutadiene diblock.

0.036 mol of dimethyldichlorosilane is subsequently introduced into the reactor. The reaction medium is maintained at 5° C. for 12 minutes. The polymer obtained on conclusion of this coupling stage is a poly(α-methylstyrene)-b-polybutadiene-b-poly(α-methylstyrene) triblock polymer which exhibits three populations by SEC analysis:
M_{n,1}=11 000 g/mol (2%), corresponding to free PAMS,
M_{n,2}=55 000 (5%), corresponding to PAMS-b-polybutadiene diblock, and
M_{n,3}=113 000 (93%), corresponding to PAMS-b-polybutadiene-b-PAMS triblock.

The content by weight of total poly(α-methylstyrene) chains in the final sample, measured by NMR, is 28%.

The content by weight of bonded poly(α-methylstyrene) block, with respect to the total weight of diblock and of triblock in the final sample, is 27%.

The dry polymer is recovered by stripping and then drying in an oven.

C-Synthesis of a Poly(α-methylstyrene)-b-polybutadiene-b-poly(α-methylstyrene) Triblock Polymer C Having 38% by Weight of Total Poly(α-methylstyrene):

8.47 kg of methylcyclohexane, 5 kg of α-methylstyrene and 0.625 mol of tetrahydrofurfuryl ethyl ether are introduced into an 80 litre reactor. After neutralization of the impurities with n-butyllithium, 0.125 mol of s-butyllithium is introduced. After 2 h 24 min at T=5° C., the conversion of α-methylstyrene, measured by solids content, is 49%. Analysis of the polymer by size exclusion chromatography shows the presence of a single population: Mₙ=18 000 g/mol. The Tg, measured by DSC, is 143° C.

At the end of these 2 h 24 min at 5° C., 20 kg of methylcyclohexane, the impurities of which have been pre-neutralized with n-butyllithium, are introduced into the reactor and then 4.3 kg of butadiene are introduced by means of a pump at a flow rate of 13 kg/h. The reaction medium is maintained at 5° C. At the end of the 21 minutes requiring the introduction of the 4.3 kg of butadiene, the medium is maintained at 5° C. for 5 additional minutes. The butadiene conversion at the end of these 26 minutes at 5° C. is 85%. Analysis of the polymer by size exclusion chromatography shows the presence of two populations: M_{n,1}=10 400 g/mol (2%), corresponding to free PAMS, and M_{n,2}=37 700 g/mol (98%), corresponding to PAMS-b-polybutadiene diblock.

0.06 mol of dimethyldichlorosilane is subsequently introduced into the reactor. The reaction medium is maintained at 5° C. for 12 minutes. The polymer obtained on conclusion of this coupling stage is a poly(α-methylstyrene)-b-polybutadiene-b-poly(α-methylstyrene) triblock polymer which exhibits three populations by SEC analysis:
M_{n,1}=10 000 g/mol (2%), corresponding to free PAMS,
M_{n,2}=38 000 (4%), corresponding to PAMS-b-polybutadiene diblock, and
M_{n,3}=77 000 (94%), corresponding to PAMS-b-polybutadiene-b-PAMS triblock.

The content by weight of total poly(α-methylstyrene) chains in the final sample, measured by NMR, is 38%.

The content by weight of bonded poly(α-methylstyrene) block, with respect to the total weight of diblock and of triblock in the final sample, is 37%.

The dry polymer is recovered by stripping and then drying in an oven.

D-Synthesis of the Poly(α-methylstyrene) Polymer D:

13.3 kg of methylcyclohexane, 30 kg of α-methylstyrene and 1.73 mol of tetrahydrofuran are introduced into an 80 litre reactor. After neutralization of the impurities with n-butyllithium, 0.75 mol of s-butyllithium is introduced. After 66 minutes at T=20° C., the degree of conversion of α-methylstyrene, measured by solids content, is 53%. This degree is determined by weighing an extract dried at 140° C. under a reduced pressure of 200 mmHg. The polymerization is halted by addition of methanol to the reaction medium (2 eq/Li) and the dry polymer is recovered by stripping and then drying in an oven. Analysis of the polymer by size exclusion chromatography shows the presence of a single population: Mₙ=19 100 g/mol. The Tg, measured by DSC, is 160° C.

E-Preparation of the Elastomer Matrices of Poly(α-methylstyrene)-b-polybutadiene-b-poly(α-methylstyrene) Triblock and Poly(α-methylstyrene) Polymers:

For the production of the mixtures of poly(α-methylstyrene)-b-polybutadiene-b-poly(α-methylstyrene) triblock+poly(α-methylstyrene)+poly(α-methylstyrene)-b-polybutadiene diblock polymers having controlled proportions, the contents by weight of polymer in g/l of the solutions containing the polymers A to D were measured by solids content. The volumes to be mixed of the solutions A to D recovered at the end of the polymerizations were adjusted so as to obtain the targeted proportions of polymer (cf. Table 1 below for the targeted ratios). The solutions in methylcyclohexane were mixed for one hour at ambient temperature and then the dry mixture of polymers was recovered by stripping and then drying by devolatilization in an oven.

TABLE 1

| Matrix | 1 | 2 | 3 | 4 | 5 | 6 |
|---|---|---|---|---|---|---|
| Polymer A | 100% | | | 87% | | 74% |
| Polymer B | | 100% | | | 86% | |
| Polymer C | | | 100% | | | |
| Polymer D | | | | 13% | 14% | 26% |

The elastomer matrices thus obtained by compounding are shaped by moulding for the measurement of their physical, mechanical or dynamic properties.

The results are given in Table 2 below. The contents are expressed as percentage by weight, with respect to the total weight of the elastomer matrix.

TABLE 2

| | | | | 4 | 5 | 6 |
|---|---|---|---|---|---|---|
| | | | | Matrix | Matrix | Matrix |
| Elastomer | 1 | 2 | 3 | 1 + free | 2 + free | 1 + free |
| matrix | Control | Control | Control | PAMS | PAMS | PAMS |
| Content* | 15 | 28 | 38 | 26 | 38 | 37 |
| of total | | | | | | |
| PAMS | | | | | | |
| Content* | 84 | 92 | 94 | 72 | 79 | 62 |
| of triblock | | | | | | |
| Content* | 14 | 6 | 4 | 13 | 5 | 11 |
| of diblock | | | | | | |
| Content* | 2 | 2 | 2 | 15 | 16 | 27 |
| of free | | | | | | |
| PAMS | | | | | | |
| Hysteresis | 0.055 | 0.159 | 0.360 | 0.062 | 0.278 | 0.069 |
| Tan δ max | | | | | | |
| 60° C. | | | | | | |

*the contents are expressed as % by weight, with respect to the total weight of the elastomer matrix

It emerges from the results given in the table that:
the presence in the elastomer matrix 4 of a content of 15% by weight of a poly(α-methylstyrene) polymer according to the invention makes it possible to reduce the hysteresis of the material, at the same total content of poly(α-methylstyrene), with respect to the control matrix 2 which comprises 2% by weight of a poly(α-methylstyrene) polymer;
the presence in the elastomer matrices 5 and 6 of a content respectively of 16% and 27% by weight of a poly(α-methylstyrene) polymer according to the invention makes it possible to reduce the hysteresis of the material, at the same total content of poly(α-methylstyrene), with respect to the control matrix 3 which comprises 2% by weight of a poly(α-methylstyrene) polymer.

Thus, it is found that, by increasing the content of thermoplastic polymer comprising α-methylstyrene units in an elastomer matrix, without increasing the total content of thermoplastic chains comprising α-methylstyrene units, it is possible to reduce the tan δ at 60° C. values and thus to lower the hysteresis of the elastomer matrix comprising a mixture of a triblock thermoplastic elastomer comprising a central diene elastomer block and terminal thermoplastic blocks comprising α-methylstyrene units, and from 2% to 20% of a diblock thermoplastic elastomer comprising a thermoplastic block comprising α-methylstyrene units.

1.-15. (canceled)

16. An elastomer matrix comprising:
a triblock thermoplastic elastomer having a central diene elastomer block and two terminal thermoplastic blocks comprising α-methylstyrene units bonded to the central diene elastomer block;
from 2% to 20% by weight, with respect to a total weight of the elastomer matrix, of a diblock thermoplastic elastomer having a diene elastomer block and a thermoplastic block comprising α-methylstyrene units; and
more than 10% by weight, with respect to the total weight of the elastomer matrix, of a thermoplastic polymer comprising α-methylstyrene units,
wherein a content of the thermoplastic blocks of the triblock and diblock thermoplastic elastomers is at least 10% by weight, with respect to a total weight of the triblock and diblock thermoplastic elastomers,
wherein a content of thermoplastic chains comprising α-methylstyrene units is at most 55% by weight, with respect to the total weight of the elastomer matrix, and
wherein the thermoplastic chains comprising α-methylstyrene units are constituted of chains of the thermoplastic polymer comprising α-methylstyrene units and of the thermoplastic blocks of the triblock and diblock thermoplastic elastomers.

17. The elastomer matrix according to claim 16, wherein the elastomer matrix comprises at most 45% by weight, with respect to the total weight of the elastomer matrix, of the thermoplastic polymer comprising α-methylstyrene units.

18. The elastomer matrix according to claim 16, wherein the elastomer matrix comprises at least 20% by weight, with respect to the total weight of the elastomer matrix, of the thermoplastic chains comprising α-methylstyrene units.

19. The elastomer matrix according to claim 16, wherein the elastomer matrix comprises at least 15% by weight, with respect to the total weight of the elastomer matrix, of the thermoplastic polymer comprising α-methylstyrene units.

20. The elastomer matrix according to claim 16, wherein the elastomer matrix comprises predominantly the triblock thermoplastic elastomer.

21. The elastomer matrix according to claim 16, wherein the elastomer matrix comprises at most 80% by weight of the triblock thermoplastic elastomer.

22. The elastomer matrix according to claim 16, wherein a content of the thermoplastic blocks comprising α-methylstyrene units is at least 15% by weight, with respect to the total weight of the triblock and diblock thermoplastic elastomers.

23. The elastomer matrix according to claim 16, wherein a content of the thermoplastic blocks comprising α-methylstyrene units is at most 45% by weight, with respect to the total weight of the triblock and diblock thermoplastic elastomers.

24. The elastomer matrix according to claim 16, wherein the central diene elastomer block of the triblock thermoplastic elastomer and the diene elastomer block of the diblock thermoplastic elastomer comprise units resulting from butadiene.

25. The elastomer matrix according to claim 16, wherein the central diene elastomer block of the triblock thermoplastic elastomer and the diene elastomer block of the diblock thermoplastic elastomer additionally comprise units resulting from a vinylaromatic monomer.

26. The elastomer matrix according to claim 16, wherein the thermoplastic blocks of the triblock and diblock thermoplastic elastomers comprising α-methylstyrene units predominately comprise units resulting from α-methylstyrene.

27. The elastomer matrix according to claim 16, wherein the thermoplastic blocks of the triblock and diblock thermoplastic elastomers comprising α-methylstyrene units are essentially constituted of units resulting from α-methylstyrene.

28. The elastomer matrix according to claim 16, wherein the thermoplastic polymer comprising α-methylstyrene units comprises predominately units resulting from α-methylstyrene.

29. The elastomer matrix according to claim 16, wherein the thermoplastic polymer comprising α-methylstyrene units is an α-methylstyrene homopolymer.

30. The elastomer matrix according to claim 16, wherein the central diene elastomer block of the triblock thermoplastic elastomer and the diene elastomer block of the diblock thermoplastic elastomer comprise units resulting from butadiene,
wherein the thermoplastic blocks of the triblock and diblock thermoplastic elastomers are constituted of poly(α-methylstyrene),
wherein the thermoplastic polymer comprising α-methylstyrene units is a poly(α-methylstyrene),
wherein the content of thermoplastic blocks of the triblock and diblock thermoplastic elastomers comprising α-methylstyrene units is at least 10% by weight and at most 45% by weight, with respect to the total weight of the triblock thermoplastic elastomer and of the diblock thermoplastic elastomer,
wherein the elastomer matrix comprises more than 10% by weight and at most 45% by weight, with respect to the total weight of the elastomer matrix, of the thermoplastic polymer comprising α-methylstyrene units, and
wherein the content of thermoplastic chains comprising α-methylstyrene units is at least 20% by weight and at most 55% by weight, with respect to the total weight of the elastomer matrix.
